(19) United States
(12) Patent Application Publication
(10) Pub. No.: US 2021/0138734 A1
(43) Pub. Date: May 13, 2021

(54) FOAMING AGENT INCORPORATED INTO A THERMOPLASTIC FOR AN ADDITIVE MANUFACTURING SYSTEM

(71) Applicant: The Boeing Company, Chicago, IL (US)

(72) Inventors: Douglas Dean Maben, Snohomish, WA (US); Xiaoxi Wang, Mukilteo, WA (US)

(21) Appl. No.: 16/682,839

(22) Filed: Nov. 13, 2019

(51) Int. Cl. B29C 64/393; B29C 64/118; B29C 64/295; B33Y 70/00; B33Y 10/00; B33Y 30/00; B33Y 50/02; B29C 64/209

(52) U.S. Cl. CPC B29C 64/393; B29C 64/118; B29C 64/295; B33Y 70/00; B29K 2101/12; B33Y 30/00; B33Y 50/02; B29C 64/209; B33Y 10/00

(57) ABSTRACT

An additive manufacturing system is disclosed and includes a first heating element configured to receive a first supply of thermoplastic material and a second heating element configured to receive a second supply of plastic material. A foaming agent is incorporated into the second supply of plastic material and is configured to expand at an activation temperature. The additive manufacturing system also includes a control module in electronic communication with both the first heating element and the second heating element. The control module executes instructions to instruct the first heating element to heat the first supply of thermoplastic material to a first extrusion temperature and instruct the second heating element to heat the second supply of plastic material to a second extrusion temperature. The second extrusion temperature is equal to or greater than the activation temperature of the foaming agent.

### INTRODUCTION

The present disclosure relates to additive manufacturing systems. In particular, the present disclosure is directed towards foaming agents that are incorporated into a plastic material for an additive manufacturing system.

### BACKGROUND

Foam parts may include any number of shapes and profiles. Some foam parts are created using various subtractive manufacturing operations that cut away or otherwise remove portions of foam to create a final shape. For example, a foam part may be fabricated into its final shape by first skiving a portion of foam from bun stock, which may also be referred to as foam stock. As used herein, the term skive means to cutoff, pare, or otherwise remove material. The portion of foam skived from the bun may then be machined into an approximate shape, and subsequently molded into the final shape. However, these subtractive operations tend to require extensive resources such as, for example, programming, machine time, equipment, tooling, and wasted material.

In contrast to subtractive operations, additive manufacturing operations build a part by depositing material one layer at a time to create a three dimensional structure. There are various types of additive manufacturing operations. For example, one type of additive manufacturing process is fused filament fabrication. Fused filament fabrication employs a continuous filament of material that is typically composed of a thermoplastic. The continuous filament of thermoplastic is extruded from a nozzle, one layer at a time, to build a three dimensional component.

### SUMMARY

According to several aspects, an additive manufacturing system is disclosed, and includes a first heating element configured to receive a first supply of thermoplastic material and a second heating element configured to receive a second supply of plastic material. A foaming agent is incorporated into the second supply of plastic material and is configured to expand at an activation temperature. The additive manufacturing system also includes control module in electronic communication with both the first heating element and the second heating element. The control module executes instructions to instruct the first heating element to heat the first supply of thermoplastic material to a first extrusion temperature and instruct the second heating element to heat the second supply of plastic material to a second extrusion temperature. The second extrusion temperature is equal to or greater than the activation temperature of the foaming agent.

In another aspect, a method of operating an additive manufacturing system is disclosed. The method includes instructing, by a computer, a first heating element to heat a first supply of thermoplastic material to a first extrusion temperature. The method also includes instructing, by the computer, a second heating element to heat a second supply of plastic material to a second extrusion temperature. A foaming agent is incorporated into the second supply of plastic material and is configured to expand at an activation temperature, and the second extrusion temperature is equal to or greater than the activation temperature.

In still another embodiment, an additive manufacturing system is disclosed, and includes a heating element configured to receive a first supply of thermoplastic material and an expandable foam dispenser including a storage canister and a valve. The storage canister stores an expandable foam under pressure. The additive manufacturing system also includes a control module in electronic communication with both the heating element and the valve. The control module executes instructions to instruct the heating element to heat the first supply of thermoplastic material to a first extrusion temperature and activate the valve.

The features, functions, and advantages that have been discussed may be achieved independently in various embodiments or may be combined in other embodiments further details of which can be seen with reference to the following description and drawings.

### BRIEF DESCRIPTION OF THE DRAWINGS

The drawings described herein are for illustration purposes only and are not intended to limit the scope of the present disclosure in any way.

FIG. 1 illustrates the disclosed additive manufacturing system including a first supply of thermoplastic material, a second supply of plastic material, a dual head nozzle, and a build plate, according to an exemplary embodiment;

FIG. 2A illustrates an alternative embodiment of the additive manufacturing system of shown in FIG. 1 employing two discrete nozzles, according to an exemplary embodiment;

FIG. 2B illustrates yet another embodiment of the additive manufacturing system where the dual head nozzle includes a single heating element, according to an exemplary embodiment;

FIG. 2C illustrates the second supply of plastic material and a foaming agent, according to an exemplary embodiment;

FIG. 3A illustrates a first extrusion path of the additive manufacturing system, according to an exemplary embodiment;

FIG. 3B illustrates a second extrusion path of the additive manufacturing system, according to an exemplary embodiment;

FIGS. 4A-4F illustrate various embodiments of components that are created by the disclosed additive manufacturing system, according to an exemplary embodiment;

FIG. 5 is an exemplary process flow diagram illustrating a method for operating the additive manufacturing system shown in FIG. 1, according to an exemplary embodiment;

FIG. 6 is an alternative embodiment of the additive manufacturing system shown in FIG. 1 including an expandable foam canister, according to an exemplary embodiment; and

FIG. 7 is an exemplary computer system for operating the disclosed additive manufacturing system.

### DETAILED DESCRIPTION

The present disclosure is directed towards foaming agents that are incorporated into a plastic material for an additive manufacturing system. In an embodiment, the disclosed additive manufacturing system includes a first supply of thermoplastic material and a second supply of plastic material. A foaming agent is incorporated into the second supply of plastic material. The foaming agent is configured to expand at an activation temperature. When the foaming agent releases the gas, bubbles or cells are created within the second supply of plastic material to create a cellular structure. Alternatively, in another embodiment, instead of a foaming agent incorporated into thermoplastic material, the additive manufacturing system includes a canister that stores an expandable foam under pressure.

The following description is merely exemplary in nature and is not intended to limit the present disclosure, application, or uses.

Referring to FIG. 1, an exemplary additive manufacturing system 10 is shown. The additive manufacturing system 10 includes a first supply of thermoplastic material 20, a second supply of plastic material 22, a dual head nozzle 24, a first heating element 26, a second heating element 28, a build plate 32, a drive mechanism 34, and a control module 36 in electronic communication with the dual head nozzle 24, the first heating element 26, and the second heating element 28. The first heating element 26 and the second heating element 28 are both part of the dual head nozzle 24. In the embodiment as shown in FIGS. 1 and 2A, the first heating element 26 and the second heating element 28 are discrete elements. However, in the alternative embodiment as shown in FIG. 2B, the first heating element 26 and the second heating element 28 are both part of a single heating element 30. That is, the single heating element 30 is configured to heat both the first supply of thermoplastic material 20 and the second supply of plastic material 22.

As explained below, the disclosed additive manufacturing system 10 is configured to build a three-dimensional component 38. The component 38 includes both a solid section 44 that is constructed of the first supply of thermoplastic material 20 and a foam section 46 constructed of the second supply of plastic material 22. In the embodiment as shown in FIG. 1, the component 38 is shown having a rigid, square-shaped outer shell 48 that is filled with a foam material 49, which is created by a foaming agent 54 seen in FIG. 2C. The foaming agent 54 is described in greater detail below.

In the embodiment as shown in FIG. 1, the additive manufacturing system 10 is a fused filament fabrication system where the first supply of thermoplastic material 20 and the second supply of plastic material 22 are both constructed of respective filaments 40, 42 of thermoplastic material. Specifically, in the exemplary embodiment as shown in FIG. 1, a first filament 40 is wound around a first spool 50 and a second filament 42 is wound around a second spool 52. Although FIG. 1 illustrates two spools 50, 52, it is to be appreciated that the additive manufacturing system 10 may also include more than two spools as well, where materials having different properties such as hardness, foam density, or cell structure are included as well.

Continuing to refer to FIG. 1, the second supply of plastic material 22 is a thermoplastic or, alternatively, a thermoset. In an embodiment, the first supply of thermoplastic material 20 and the second supply of plastic material 22 are constructed of identical thermoplastics or, alternatively, of dissimilar plastics. For example, in one embodiment both the first supply of thermoplastic material 20 and the second supply of plastic material 22 are both a thermoplastic polyurethane. In an embodiment the first supply of thermoplastic material 20 and the second supply of plastic material 22 are composed of materials such as, but not limited to, polyolefins, polystyrene, polyamide (PA), thermoplastic polyurethane (TPU), polyetherimide (PEI), polyetheretherketone (PEEK), and polyetherketoneketone (PEKK). In another embodiment, the first supply of thermoplastic material 20 and the second supply of plastic material 22 are a hybrid of a thermoset and a thermoplastic such as, for example, epoxy, phenolic, or urethane. For example, the second supply of plastic material 22 is a polyurethane foam having a polyol component and a diisocyanate component. In yet embodiment, the first supply of thermoplastic material 20, the second supply of plastic material 22, or both include fiber reinforcement materials such as, but not limited to, carbon fiber and fiber glass. In this embodiment, the fiber reinforced portion is added for structural rigidity where the non-reinforced portion may be utilized to take advantage of other unique material properties such as, for example, density, thermal characteristics, and acoustics.

Referring to both FIGS. 1 and 2C, the second supply of plastic material 22 includes the foaming agent 54. Specifically, as seen in FIG. 2C, the foaming agent 54 is incorporated into the second supply of plastic material 22 and is configured to release a gas that causes the foam or expand at an activation temperature. The gas may be, for example, nitrogen, carbon dioxide, or carbon monoxide. When heated to the activation temperature, the foaming agent 54 releases the gas, and thereby forms bubbles or cells within the second supply of plastic material 22. In other words, a cellular structure is created within the second supply of plastic material 22 as the gas is released. The cellular structure may be open cell or, alternatively, closed cell. In the embodiment as shown, the foaming agent 54 is a powder, however, it is to be appreciated that the foaming agent 54 is not limited to powder and may be in the form of particles or liquid.

The foaming agent 54 is a physical foaming agent, a chemical foaming agent, or a combination of both. Some examples of the chemical foaming agent include, but are not limited to, citric acid, sodium carbonate, benzene sulfonyl hydrazide, or azodicarbonamide. Some examples of the physical foaming agent include, but are not limited to, chlorofluorocarbons, hydrofluorocarbons, propane, carbon dioxide or nitrogen. The activation temperature of the foaming agent 54 is greater than a glass transition temperature. In an embodiment, the activation temperature is less than a melting temperature of the second supply of plastic material 22. However, there is instances when the activation temperature is above the melting temperature so that the second supply of plastic material 22 foams more quickly. It is to be appreciated that the actual values of the glass transition temperature vary depending on the specific type of thermoplastic material. It is also to be appreciated that the glass transition temperature of a thermoplastic material is actually a range of temperatures that are all below the melting temperature of the thermoplastic material. Thus, for purposes of this disclosure, the glass transition temperature refers to any temperature that is at least equal to an onset glass transition temperature of the second supply of plastic material 22.

Continuing to refer to FIG. 1, the first heating element 26 is configured to receive the first supply of thermoplastic material 20, and the second heating element 28 is configured to receive the second supply of plastic material 22. Specifically, in the embodiment as shown, the first filament 40, which is constructed of the first supply of thermoplastic material 20, is supplied to the first heating element 26. Similarly, the second filament 42, which is constructed of the second supply of plastic material 22, is supplied to the second heating element 28.

The control module 36 is in electronic communication with both the first heating element 26 and the second heating element 28 and executes instructions to instruct the first heating element 26 to heat the first supply of thermoplastic material 20 to a first extrusion temperature. Once the first supply of thermoplastic material 20 is heated to the first extrusion temperature, the first supply of thermoplastic material 20 is extruded through a first opening 64 in the dual head nozzle 24 and is deposited onto the build plate 32. Similarly, the control module 36 instructs the second heating element 28 to heat the second supply of plastic material 22 to a second extrusion temperature, where the second extrusion temperature is equal to or greater than the activation temperature of the foaming agent 54 (FIG. 2C).

Once the second supply of plastic material 22 is heated to the second extrusion temperature, the second supply of plastic material 22 releases the gas to become a foamed thermoplastic 70. As seen in FIG. 1, the foamed thermoplastic 70 is extruded through a second opening 66 in the dual head nozzle 24 and is deposited onto the component 38 disposed on the build plate 32. Thus, the first supply of thermoplastic material 20 and the second supply of plastic material 22 are heated to their respective extrusion temperatures and are extruded onto a working surface 72 of the build plate 32 to create the component 38.

The drive mechanism 34 is operably connected to and propels the dual head nozzle 24. The control module 36 instructs the drive mechanism 34 to propel the dual head nozzle 24 relative to the build plate 32 to build the component 38. Specifically, the drive mechanism 34 propels the dual head nozzle 24 relative to an x-axis and a y-axis of the build plate 32. The x-axis and the y-axis represent side-to-side movement along the working surface 72 of the build plate 32. The drive mechanism 34 also propels the dual head nozzle 24 to travel in a direction perpendicular to the build plate 32 (i.e., up-and-down motion), which is shown in FIG. 1 as a z-axis. Thus, the dual head nozzle 24 is moveable in the x, y, and z-axes relative to the build plate 32.

Referring now to FIGS. 1 and 3A, the control module 36 instructs the dual head nozzle 24 (via the drive mechanism 34) to travel along a first extrusion path 76 relative to the build plate 32, while the first heating element 26 is heating the first supply of thermoplastic material 20 to the first extrusion temperature. As the dual head nozzle 24 travels along the first extrusion path 76, the first supply of thermoplastic material 20 is deposited on the build plate 32, and/or previously deposited layers of thermoplastic material 20, to create the solid section 44 of the components 38. For example, in the embodiment as shown in the figures, the first extrusion path 76 is in the shape of a hollow square to correspond with the solid section 44 of the component 38.

Referring now to FIGS. 1 and 3B, the control module 36 also instructs the dual head nozzle 24 to travel along a second extrusion path 78 relative to the build plate 32, where the second heating element 28 heats the second supply of plastic material 22 to the second extrusion temperature as the dual head nozzle 24 travels along the second extrusion path 78. As the dual head nozzle 24 travels along the second extrusion path 78, the second supply of plastic material 22 exits the second opening 66 in the form of the foamed thermoplastic 70 and is deposited along the build plate 32 to create the foam section 46 of the components 38. For example, in the embodiment as shown in the figures, the second extrusion path 78 is in the shape of a solid cube to correspond with the foam section 46 of the component 38.

Referring to FIGS. 1, 3A, and 3B, in one embodiment, the control module 36 first instructs the dual head nozzle 24 to move along the first extrusion path 76 to deposit the first supply of thermoplastic material 20 along the build plate 32. Once the dual head nozzle 24 completes traveling along the first extrusion path 76, then the control module 36 instructs the dual head nozzle 24 to travel along the second extrusion path 78 to deposit the foamed thermoplastic 70. In other words, in the exemplary embodiment, the solid section 44 of the components 38 is created first, and the foam section 46 of the components 38 is built subsequent to the solid section 44. For example, if the solid section 44 of the components 38 represent scaffolding, then the scaffolding is built first, and the foam section 46 is then added to the components 38.

Alternatively, in another embodiment, the control module 36 instructs the dual head nozzle 24 to move along the first extrusion path 76 and the second extrusion path 78 at the same time. In one embodiment, the dual head nozzle 24 deposits the first supply of thermoplastic material 20 and the foamed thermoplastic 70 simultaneously along the build plate 32. Furthermore, if the first heating element 26 and the second heating element 28 are in the form of the single heating element 30 (FIG. 2B), then the first supply of thermoplastic material 20 and the second supply of plastic material 22 are heated together and are extruded onto the build plate 32 together. Alternatively, in another embodiment, the dual head nozzle 24 deposits the first supply of thermoplastic material 20 and the foamed thermoplastic 70 asynchronously.

Although FIG. 1 illustrates a dual head nozzle 24, in another embodiment the additive manufacturing system 10 include two discrete nozzles 80, 82, which are shown in FIG. 2A. Referring to FIGS. 1, 2A, 3A, and 3B, the additive manufacturing system 10 includes a first nozzle 80 and a second nozzle 82. The first heating element 26 is part of the first nozzle 80 and the second heating element 28 is part of the second nozzle 82. The drive mechanism 34 is operably connected to and propels the first nozzle 80 and the second nozzle 82. The control module 36 instruct the first nozzle 80 to travel along the first extrusion path 76 (FIG. 3A) relative to the build plate 32, where the first heating element 26 heats the first supply of thermoplastic material 20 to the first extrusion temperature as the first nozzle 80 travels along the first extrusion path 76 (FIG. 3A). Similarly, the control module 36 instructs the second nozzle 82 to travel along the second extrusion path 78 (FIG. 3B) relative to the build plate 32, where the second heating element 28 heats the second supply of plastic material 22 to the second extrusion temperature as the second nozzle 82 travels along the second extrusion path 78.

Similar to the dual head nozzle 24, in one approach the control module 36 first instructs the first nozzle 80 to move along the first extrusion path 76 to deposit the first supply of thermoplastic material 20 along the build plate 32. Once the first nozzle 80 completes traveling along the first extrusion path 76, then the control module 36 instructs the second nozzle 82 to travel along the second extrusion path 78 to deposit the foamed thermoplastic 70. Alternatively, in another embodiment, the control module 36 instructs the first nozzle 80 to travel in the first extrusion path 76 and the second nozzle 82 to travel in the second extrusion path 78 at the same time.

FIGS. 4A-4E illustrate various examples of the components 38 shown in FIG. 1. For example, 4A illustrates the component 38 as a foam grip handle, where the solid section 44 is a handle 100 and the foam section 46 is a grip 103. In the embodiment as shown in FIG. 4B, the component 38 is an armrest and the solid section 44 is a frame 104 and the foam section 46 is a padded exterior 106. In still another embodiment shown in FIG. 4C the component 38 is a foam wheel, where solid section 44 is an outer layer 110 and the foam section 46 is a foam-filled cavity 112. In the embodiment as shown in FIG. 4D the component 38 is a panel, where the solid section 44 is a rigid panel 114 and the foam section 46 is a foamed panel 116. The foamed panel 116 may include a textured outer surface 118.

In the embodiment as shown in FIG. 4E the component 38 is a foam-filled lattice structure, where the solid section 44 is a lattice structure 120 and the foam section 46 fills an interior cavity 122 of the lattice structure 120. FIG. 4F illustrates the component 38 having a venting mechanism that allows for any excess foamed thermoplastic material 128 to escape. Specifically, the solid section 44 of the component 38 includes one or more venting holes 124 that allow for the excess foamed thermoplastic material 128 to escape though. The excess foamed thermoplastic material 128 may be trimmed at a later time.

FIG. 5 is an exemplary process flow diagram illustrating a method 200 of operating the additive manufacturing system 10 shown in FIG. 1. Referring to FIGS. 1 and 5, the method 200 begins at block 202. In block 202, the control module 36 instructs the first heating element 26 to heat the first supply of thermoplastic material 20 to the first extrusion temperature. Similarly, the control module 36 instructs the second heating element 28 to heat the second supply of plastic material 22 to a second extrusion temperature. As mentioned above, the foaming agent 54 (FIG. 2C) is incorporated into the second supply of plastic material 22 and is configured to expand at the activation temperature, where the second extrusion temperature is equal to or greater than the activation temperature. The method 200 may then proceed to either block 204 or 206. Specifically, if the additive manufacturing system 10 includes a dual head nozzle 24 as seen in FIG. 1, then the method 200 proceeds to block 204.

In block 204, the control module 36 instructs the dual head nozzle 24 to travel along the first extrusion path 76 (FIG. 3A) relative to the build plate 32 as the first heating element 26 heats the first supply of thermoplastic material 20 to the first extrusion temperature. The control module 36 also instructs the dual head nozzle 24 to travel along the second extrusion path 78 (FIG. 3B) relative to the build plate 32 as the second heating element 28 heats the second supply of plastic material 22 to the second extrusion temperature.

Alternatively, in another embodiment, if the additive manufacturing system 10 include two discrete nozzles (i.e., the first nozzle 80 and the second nozzle 82 seen in FIG. 2A), then the method 200 proceeds from block 202 to block 206. In block 206, the control module 36 instructs the first nozzle 80 to travel along the first extrusion path 76 (FIG. 3A) relative to the build plate 32 as the first heating element 26 heats the first supply of thermoplastic material 20 to the first extrusion temperature. Similarly, the control module 36 instructs the second nozzle 82 to travel along the second extrusion path 78 (FIG. 3B) relative to the build plate 32 as the second heating element 28 heats the second supply of plastic material 22 to the second extrusion temperature.

FIG. 6 is an alternative embodiment of the additive manufacturing system 10 shown in FIG. 1. Specifically, the additive manufacturing system 10 includes a nozzle 180 having a heating element 126 and a second expandable foam dispenser 182. Referring to FIGS. 1 and 5, the second expandable foam dispenser 182 includes a storage canister 184 and a valve 186, where the control module 36 is in electronic communication with the valve 186. The storage canister 184 stores an expandable foam 190 under pressure, wherein the expandable foam 190 is in an unexpanded form when stored within the storage canister 184. In an embodiment, a two-part or three-part mixer is used to activate foaming while as the expandable foam 190 is in the process of foaming. In the embodiment as shown, a two-part mixer 192 having two mixing tubes 194 are fluidly connected to the storage canister 184. The valve 186 is fluidly connected with the contents of the storage canister 184. As seen in FIG. 6, the control module 36 activates the valve 186. In response to being activated, the valve 186 releases the expandable foam 190 from the storage canister 184 and onto the build plate 32. Some examples of the expandable foam 190 include, but are not limited to, polyisocyanurate and polyurethane.

It is to be appreciated that the nozzle 180 and the second expandable foam dispenser 182 are also propelled by the drive mechanism 34. The control module 36 instruct the nozzle 180 (via the drive mechanism 34) to travel along the first extrusion path 76 relative to the build plate 32, where the first heating element 26 heats the first supply of thermoplastic material 20 to the first extrusion temperature as the nozzle 180 travels along the first extrusion path 76 (FIG. 3A). The control module 36 also instructs the second expandable foam dispenser 182 to travel along the second extrusion path 78 (FIG. 3B) relative to the build plate 32, where the valve 186 is opened and the expandable foam 190 exits the storage canister 184 as the second nozzle 82 travels along the second extrusion path 78.

In one approach the control module 36 first instructs the nozzle 180 to move along the first extrusion path 76 to deposit the first supply of thermoplastic material 20 along the build plate 32. Once the nozzle 180 completes traveling along the first extrusion path 76 (FIG. 3A), then the control module 36 instructs the second expandable foam dispenser 182 to travel along the second extrusion path 78 (FIG. 3B) to deposit the expandable foam 190. Alternatively, in another embodiment, the control module 36 instructs the nozzle 180 to travel in the first extrusion path 76 and the second expandable foam dispenser 182 to travel in the second extrusion path 78 at the same time.

Referring generally to the figures, the disclosed additive manufacturing system provides an approach for creating hybrid foam parts having a solid section and a foamed section. The hybrid components fabricated by the disclosed additive manufacturing system are thereby co-molded by a single system. In contrast, conventional approaches typically require the foamed section and the solid section to be made separately and then joined together in an additional operation. The disclosed additive manufacturing system eliminates the additional joining operation used to assemble the solid section to the foam section. Furthermore, foam parts are often fabricated using subtractive manufacturing operations that cut away or otherwise remove portions of foam to create a final shape, which wastes material. Subtractive manufacturing operation also require extensive resources such as, programming, machine time, equipment, and tooling. The disclosed additive manufacturing system does not result in wasted material or require the extensive resources that are usually found in subtractive manufacturing operations.

Referring now to FIG. 7, the control module 36 is implemented on one or more computer devices or systems, such as exemplary computer system 1030. The computer system 1030 includes a processor 1032, a memory 1034, a mass storage memory device 1036, an input/output (I/O) interface 1038, and a Human Machine Interface (HMI) 1040. The computer system 1030 is operatively coupled to one or more external resources 1042 via the network 1026 or I/O interface 1038. External resources may include, but are not limited to, servers, databases, mass storage devices, peripheral devices, cloud-based network services, or any other suitable computer resource that may be used by the computer system 1030.

The processor 1032 includes one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 1034. Memory 1034 includes a single memory device or a plurality of memory devices including, but not limited to, read-only memory (ROM), random access memory (RAM), volatile memory, non-volatile memory, static random-access memory (SRAM), dynamic random-access memory (DRAM), flash memory, cache memory, or any other device capable of storing information. The mass storage memory device 1036 includes data storage devices such as a hard drive, optical drive, tape drive, volatile or non-volatile solid-state device, or any other device capable of storing information.

The processor 1032 operates under the control of an operating system 1046 that resides in memory 1034. The operating system 1046 manages computer resources so that computer program code embodied as one or more computer software applications, such as an application 1048 residing in memory 1034, may have instructions executed by the processor 1032. In an alternative example, the processor 1032 may execute the application 1048 directly, in which case the operating system 1046 may be omitted. One or more data structures 1049 also reside in memory 1034, and may be used by the processor 1032, operating system 1046, or application 1048 to store or manipulate data.

The I/O interface 1038 provides a machine interface that operatively couples the processor 1032 to other devices and systems, such as the network 1026 or external resource 1042. The application 1048 thereby works cooperatively with the network 1026 or external resource 1042 by communicating via the I/O interface 1038 to provide the various features, functions, applications, processes, or modules comprising examples of the disclosure. The application 1048 also includes program code that is executed by one or more external resources 1042, or otherwise rely on functions or signals provided by other system or network components external to the computer system 1030. Indeed, given the nearly endless hardware and software configurations possible, persons having ordinary skill in the art will understand that examples of the disclosure may include applications that are located externally to the computer system 1030, distributed among multiple computers or other external resources 1042, or provided by computing resources (hardware and software) that are provided as a service over the network 1026, such as a cloud computing service.

The HMI 1040 is operatively coupled to the processor 1032 of computer system 1030 in a known manner to allow a user to interact directly with the computer system 1030. The HMI 1040 may include video or alphanumeric displays, a touch screen, a speaker, and any other suitable audio and visual indicators capable of providing data to the user. The HMI 1040 also includes input devices and controls such as an alphanumeric keyboard, a pointing device, keypads, pushbuttons, control knobs, microphones, etc., capable of accepting commands or input from the user and transmitting the entered input to the processor 1032.

A database 1044 may reside on the mass storage memory device 1036 and may be used to collect and organize data used by the various systems and modules described herein. The database 1044 may include data and supporting data structures that store and organize the data. In particular, the database 1044 may be arranged with any database organization or structure including, but not limited to, a relational database, a hierarchical database, a network database, or combinations thereof. A database management system in the form of a computer software application executing as instructions on the processor 1032 may be used to access the information or data stored in records of the database 1044 in response to a query, where a query may be dynamically determined and executed by the operating system 1046, other applications 1048, or one or more modules.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An additive manufacturing system, comprising:
a first heating element configured to receive a first supply of thermoplastic material;
a second heating element configured to receive a second supply of plastic material, wherein a foaming agent is incorporated into the second supply of plastic material and is configured to expand at an activation temperature;
a control module in electronic communication with both the first heating element and the second heating element, wherein the control module executes instructions to:
instruct the first heating element to heat the first supply of thermoplastic material to a first extrusion temperature; and
instruct the second heating element to heat the second supply of plastic material to a second extrusion temperature, wherein the second extrusion temperature is equal to or greater than the activation temperature of the foaming agent.

2. The additive manufacturing system of claim 1, wherein the first heating element and the second heating element are both part of a single heating element configured to heat both the first supply of thermoplastic material and the second supply of plastic material.

3. The additive manufacturing system of claim 1, wherein the first heating element and the second heating element are both part of a dual head nozzle.

4. The additive manufacturing system of claim 3, wherein the dual head nozzle is in electronic communication with the control module, and the control module executes instructions to:
instruct the dual head nozzle to travel along a first extrusion path relative to a build plate, wherein the first heating element heats the first supply of thermoplastic material to the first extrusion temperature as the dual head nozzle travels along the first extrusion path; and
instruct the dual head nozzle to travel along a second extrusion path relative to the build plate, wherein the second heating element heats the second supply of plastic material to the second extrusion temperature as the dual head nozzle travels along the second extrusion path.

5. The additive manufacturing system of claim 4, wherein the control module instructs the dual head nozzle to move along the first extrusion path, and once the dual head nozzle completes traveling along the first extrusion path, the control module instructs the dual head nozzle to travel along the second extrusion path.

6. The additive manufacturing system of claim 4, wherein the control module instructs the dual head nozzle to move along the first extrusion path and the second extrusion path at the same time.

7. The additive manufacturing system of claim 1, wherein the first heating element is part of a first nozzle and the second heating element is part of a second nozzle.

8. The additive manufacturing system of claim 7, wherein the first nozzle and the second nozzle are in electronic communication with the control module, and the control module executes instructions to:
instruct the first nozzle to travel along a first extrusion path relative to a build plate, wherein the first heating element heats the first supply of thermoplastic material to the first extrusion temperature as the first nozzle travels along the first extrusion path; and
instruct the second nozzle to travel along a second extrusion path relative to the build plate, wherein the second heating element heats the second supply of plastic material to the second extrusion temperature as the second nozzle travels along the second extrusion path.

9. The additive manufacturing system of claim 8, wherein the control module instructs the first nozzle to travel along the first extrusion path, and once the first nozzle completes the first extrusion path, the control module instructs the second nozzle to travel along the second extrusion path.

10. The additive manufacturing system of claim 8, wherein the control module instructs the first nozzle to travel in the first extrusion path and the second nozzle to travel in the second extrusion path at the same time.

11. The additive manufacturing system of claim 1, wherein the first supply of thermoplastic and the second supply of plastic material are both constructed of respective continuous filaments of thermoplastic material.

12. The additive manufacturing system of claim 1, wherein the activation temperature of the foaming agent is greater than a glass transition temperature of the second supply of plastic material.

13. The additive manufacturing system of claim 1, wherein the foaming agent is a physical foaming agent.

14. The additive manufacturing system of claim 1, wherein the foaming agent is a chemical foaming agent.

15. A method of operating an additive manufacturing system, the method comprising:
instructing, by a computer, a first heating element to heat a first supply of thermoplastic material to a first extrusion temperature; and
instructing, by the computer, a second heating element to heat a second supply of plastic material to a second extrusion temperature, wherein a foaming agent is incorporated into the second supply of plastic material and is configured to expand at an activation temperature, and wherein the second extrusion temperature equal to or greater than the activation temperature.

16. The method of claim 15, further comprising:
instructing, by the computer, a dual head nozzle to travel along a first extrusion path relative to a build plate as the first heating element heats the first supply of thermoplastic material to the first extrusion temperature, wherein the dual head nozzle includes both the first heating element and the second heating element; and
instructing, by the computer, the dual head nozzle to travel along a second extrusion path relative to the build plate as the second heating element heats the second supply of plastic material to the second extrusion temperature.

17. The method of claim 15, further comprising:
instructing, by the computer, a first nozzle to travel along a first extrusion path relative to a build plate as the first heating element heats the first supply of thermoplastic material to the first extrusion temperature; and
instructing, by the computer, a second nozzle to travel along a second extrusion path relative to the build plate as the second heating element heats the second supply of plastic material to the second extrusion temperature.

18. The method of claim 15, wherein the activation temperature of the foaming agent is greater than a glass transition temperature of the second supply of plastic material.

19. An additive manufacturing system, comprising:
a heating element configured to receive a first supply of thermoplastic material;
an expandable foam dispenser including a storage canister and a valve, wherein the storage canister stores an expandable foam under pressure;
a control module in electronic communication with both the heating element and the valve, wherein the control module executes instructions to:
instruct the heating element to heat the first supply of thermoplastic material to a first extrusion temperature; and
activate the valve.

20. The additive manufacturing system of claim 19, wherein the valve releases the expandable foam from the storage canister in response to being activated.
